(19) United States
(12) Patent Application Publication
(10) Pub. No.: US 2018/0247335 A1
(43) Pub. Date: Aug. 30, 2018

(54) METHOD AND DEVICE FOR DISPLAYING APP RECOMMENDATION INFORMATION

(71) Applicant: BEIJING KINGSOFT INTERNET SECURITY SOFTWARE CO., LTD., Beijing (CN)

(72) Inventor: Huaidong Tang, Beijing (CN)

(73) Assignee: BEIJING KINGSOFT INTERNET SECURITY SOFTWARE CO., LTD., Beijing (CN)

(21) Appl. No.: 15/960,133

(22) Filed: Apr. 23, 2018

Related U.S. Application Data
(63) Continuation of application No. PCT/CN2016/083734, filed on May 27, 2016.

(30) Foreign Application Priority Data
Oct. 23, 2015 (CN) 201510697120.6

(51) Int. Cl. G06Q 30/02; G06F 17/30; G06F 8/61

(52) U.S. Cl. CPC G06Q 30/0254; G06F 8/61; G06F 17/30867

(57) ABSTRACT

Disclosed are a method and device for displaying APP recommendation information. The method may include: acquiring a CVR threshold for an APP, wherein a difference between an installation parameter corresponding to the CVR threshold and a desired installation parameter is within a preset range, the installation parameter is related to an installation number and generated from historical statistical information in which a CVR is equal to or higher than the CVR threshold, and the historical statistical information is acquired from historical displays of the APP recommendation information of the APP; predicting a CVR for the APP recommendation information to be displayed; and determining whether the CVR predicted is lower than the CVR threshold, if yes, not displaying the APP recommendation information, if no, displaying the APP recommendation information.

### CROSS-REFERENCE TO RELATED APPLICATION

This application is a continuation of International Application PCT/CN2016/083734, with an international filing date of May 27, 2015, which claims priority to and benefits of Chinese Patent Application Serial No. 201510697120.6, filed with the State Intellectual Property Office of P. R. China by Beijing Kingsoft Internet Security Software CO., LTD. on Oct. 23, 2015, the entire content of which is incorporated herein by reference.

### FIELD

The present disclosure relates to a field of an internet technology, and more particularly to a method and device for displaying APP recommendation information.

### BACKGROUND

With the development of the internet technology, the types and number of applications (APPs) are increasing. Currently, APP recommendation information is usually used for a terminal of a user to install an APP. For now, the APP recommendation information is displayed by a server in accordance with a preset display strategy, an APP installation number resulted from the APP recommendation information is not considered. However, the installation number of the APP is very important for a manufacturer of the APP. Therefore, the current method for display APP recommendation information is not intelligent enough.

### SUMMARY

Embodiments of the present disclosure provide a method and a device for displaying APP recommendation information, thus the APP recommendation information may be displayed more intelligently.

In a first aspect, embodiments of the present disclosure provide a method for displaying APP recommendation information, including:

acquiring a click value rate (CVR) threshold for an APP, in which a difference between an installation parameter corresponding to the CVR threshold and a desired installation parameter is within a preset range, the installation parameter is related to an installation number and generated from historical statistical information in which a CVR is equal to or higher than the CVR threshold, and the historical statistical information is acquired from historical displays of the APP recommendation information of the APP;

predicting a CVR for the APP recommendation information to be displayed; and

determining whether the CVR predicted is lower than the CVR threshold, if yes, not displaying the APP recommendation information, if no, displaying the APP recommendation information.

In a second aspect, embodiments of the present disclosure provide a device for displaying APP recommendation information, including:

a shell;

a circuit board, disposed in a space defined by the shell;

a memory, disposed on the circuit board and configured to store an executable program code;

a processor, disposed on the circuit board and configured to run a program corresponding to the executable program code by reading the executable program code stored in the memory to perform a method for displaying APP recommendation information as described hereinbefore; and

a power circuit, configured to supply power to each circuit or component of an electronic device.

In a third aspect, embodiments of the present disclosure provide a computer-readable storage medium, having stored therein one or more modules that, when executed by a terminal, causes the terminal to perform a method for displaying APP recommendation information as described hereinbefore.

### BRIEF DESCRIPTION OF THE DRAWINGS

In order to illustrate embodiments of the present disclosure or technical solutions in the prior art more clearly, drawings, which are to be used in the description of embodiments of the present disclosure or the prior art, will be briefly described in the following. It will be apparent that the drawings in the following description are only some embodiments of the present disclosure, and according to which other drawings may be obtained by those skilled in the art without inventive work.

FIG. 1 is a flow chart of a method for displaying APP recommendation information according to an embodiment of the present disclosure;

FIG. 2 is a schematic diagram of a device for displaying APP recommendation information according to an embodiment of the present disclosure;

FIG. 3 is a schematic diagram of another device for displaying APP recommendation information according to an embodiment of the present disclosure; and

FIG. 4 is a schematic diagram of a device for displaying APP recommendation information according to an embodiment of the present disclosure.

### DETAILED DESCRIPTION

The technical solutions described in embodiments of the present disclosure will be described clearly and completely with reference to drawings. It will be apparent that the described embodiments are merely part of the present disclosure and all other embodiments obtained on the basis by an ordinary person skilled in the art without creative work are within the scope of the present disclosure.

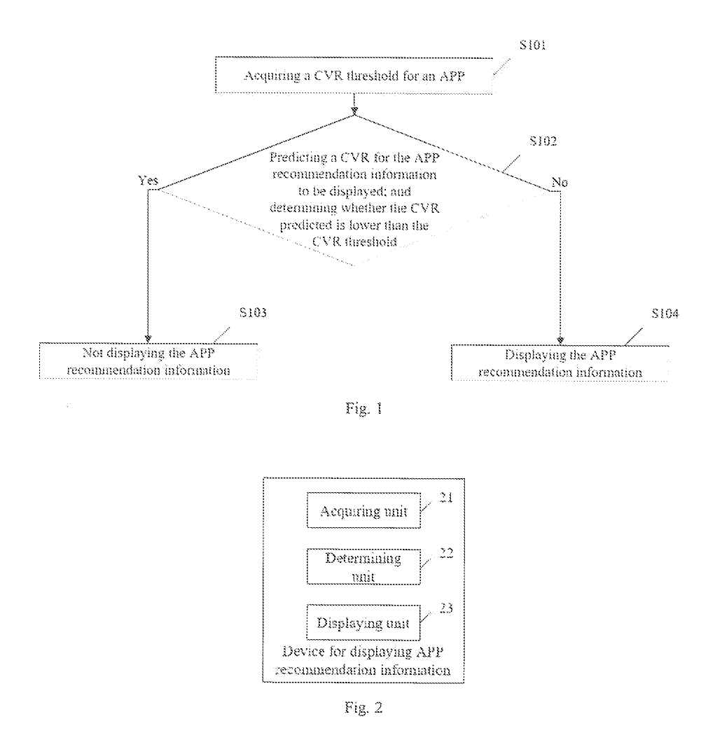

Referring to FIG. 1, which is a flow chart of a method for displaying APP recommendation information according to an embodiment of the present disclosure, the method includes steps as follows.

S101. A CVR threshold is acquired for an APP, a difference between an installation parameter corresponding to the CVR threshold and a desired installation parameter is within a preset range, where the installation parameter is related to an installation number and generated from historical statistical information in which a CVR is equal to or higher than the CVR threshold, and the historical statistical information is acquired from historical displays of the APP recommendation information of the APP.

In this embodiment, the APP mentioned above may be any APP in the field of the internet technology, such as an instant messaging APP, a game APP, a reading APP, a video APP, and so on. Further, the APP recommendation information may be taken as installation information for a user terminal to install the APP, that is, the user terminal may acquire installation data of the APP from the APP recommendation information to install the APP. In addition, the APP recommendation information may also be understood as advertisements for generalizing the APP.

In this embodiment, CVR may be understood as an indication for evaluating the effect of the APP recommendation information or advertisements when the APP recommendation information is used as the advertisements.

In this embodiment, the historical statistical information may be statistical information that is acquired from historical displays of the APP recommendation information of the APP. For example, the historical statistical information may be an accumulated installation number of the APP, an accumulated cost of the APP paid by a manufacturer, an accumulated click number of the APP recommendation information or a CVR acquired at each display of the APP recommendation information, i.e., the historical statistical information may include at least one of an accumulated installation number, an accumulated cost of the APP paid by a manufacturer or a CVR acquired at each display of the APP recommendation information. In this way, the historical statistical information may include a final cost, a final installation number and a final click number as well as a cost, an installation number and a click number generated at each display of the APP recommendation information. Consequently, it is possible to calculate a parameter related to the installation number from the historical statistical information in which a CVR is equal to or higher than the CVR threshold. For example, if the CVR threshold is 0.02, and there is a CVR of 0.0198 in the historical statistical information, then it is possible to take a difference between the final cost and the cost corresponding to the CVR of 0.0198 as a left cost and a difference between the final installation number and the installation number corresponding to the CVR of 0.0198 as a left installation number, and thus it is possible to calculate the installation parameter according to the left cost and the left installation number. In addition, the historical statistical information may be acquired within a specific time period.

Moreover, in this embodiment, the installation parameter corresponding to the CVR threshold may refer to information about a cost of each installation of the APP paid by the manufacturer of the APP, generated from the historical statistical information in which a CVR is equal to or higher than the CVR threshold. That is, the installation parameter may be the cost of each installation of the APP paid by the manufacturer of the APP, which may be defined as CPI. Thus, it is possible to control the cost of each installation of the APP paid by the manufacturer of the APP within a reasonable range, so as to improve the benefits of the manufacturer.

Furthermore, in this embodiment, the installation parameter may refer to a ratio of a display number of the APP recommendation information to the installation number of the APP, generated from the historical statistical information in which a CVR is equal to or higher than the CVR threshold. That is, the installation parameter may be the ratio of the display number of the APP recommendation information to the installation number of the APP. Thus, it is possible to control the display number of the APP recommendation information and the installation number of the APP within a reasonable range, so as to avoid a problem that displays of the APP recommendation information are excessive, but installation number of the APP is low.

S102. A CVR is predicted for the APP recommendation information to be displayed, and it is determined whether the CVR predicted is lower than the CVR threshold, if yes, S103 is executed, if no, S104 is executed.

S102 may be executed in a machine learning manner to acquire the predicted CVR of the APP recommendation information to be displayed.

S103. The APP recommendation information will not be displayed.

If the CVR predicted for the APP recommendation information to be displayed is lower than the CVR threshold, it is indicated that a difference between an installation parameter generated by displaying the APP recommendation information and the desired installation parameter is not within the preset range, the APP recommendation information will not be displayed, thus the installation parameter of the APP is controlled within a reasonable range.

S104. The APP recommendation information is displayed.

If the CVR predicted for the APP recommendation information to be displayed is greater than the CVR threshold, it is indicated that a difference between an installation parameter generated by displaying the APP recommendation information and the desired installation parameter is within the preset range, thus the APP recommendation information may be displayed.

It should be illustrated that, in this embodiment, displaying the APP recommendation information may be understood as outputting the APP recommendation information in some specific interfaces or sending the APP recommendation information to the user terminal through a specific message.

With the steps described above, it is possible to ensure the benefits of the manufacturer of the APP through not displaying useless APP recommendation information with a CVR less than the CVR threshold, without a bid adjustment of the APP recommendation information.

In this embodiment, when the installation parameter is the cost of each installation of the APP paid by the manufacturer of the APP, the CVR threshold may be generated by:

acquiring the desired installation parameter and historical statistical data generated from M displays of the APP recommendation information of the APP, where the historical statistical data includes information about CVR, installation number and cost, and M is an integer greater than 1;

taking the historical statistical data acquired as a statistical set, and dividing the historical statistical data in the statistical set into N data sets, in which each data set includes an overall CVR, and a difference between a CVR of each historical statistical data in the data set and the overall CVR is within a specific range, and N is a positive integer less than M;

removing from the statistical set a data set with a smallest overall CVR in the N data sets, and calculating a cost of each installation of the APP paid by the manufacturer of the APP from currently left statistical sets as a current installation parameter;

comparing the current installation parameter with the desired installation parameter, and taking the overall CVR of the currently removed data set as the CVR threshold if a difference between the current installation parameter and the desired installation parameter is within the preset range;

if the difference between the current installation parameter and the desired installation parameter is not within the preset range, removing from the currently left statistical sets a data set with a smallest overall CVR in the currently left statistical sets, and repeating the step of calculating a cost of each installation of the APP paid by the manufacturer of the APP from currently left statistical sets as a current installation parameter, until the CVR threshold is generated.

In this embodiment, each historical statistical data may correspond to one display of the APP recommendation information, the CVR included in the historical statistical data may be a CVR at the current display of the APP recommendation information, the installation number included in the historical statistical data may be an accumulated installation number at the current display of the APP recommendation information, and the cost information included in the historical statistical data may be an accumulated cost paid by the manufacturer of the APP at the current display of the APP recommendation information. Certainly, the historical statistical data may also include an accumulated click number at the current display of the APP recommendation information.

In addition, the number of the historical statistical data in each data set of the statistical set may be the same, or a CVR of each historical statistical data in each data set is equal to the overall CVR of the data set. For example, the historical statistical data may be ranked in an ascending order of the CVR and averagely divided into N data sets (or Bins) according to the display number. A serial number and a corresponding CVR value are recorded for each data set. For example, if the display number is 1000 in total, N is 20, the display number of each data set is 50, the display number may be understood as times the APP recommendation information is displayed, and 20 data sets are shown as follow.

TABLE 1

| Name of APP | | | | | Accumulated | | |
|---|---|---|---|---|---|---|---|
| recommendation | Last CVR | Data set | | Desired | installation | Accumulated | Accumulated |
| information | threshold | No. | CVR | CPI | number | click number | cost |
| A | 0.014840011 | 0 | 0.015695 | 2.5 | 0 | 38 | 2.468179 |
| A | 0.014840011 | 1 | 0.016383 | 2.5 | 0 | 76 | 5.128179 |
| A | 0.014840011 | 2 | 0.017186 | 2.5 | 0 | 114 | 7.677897 |
| A | 0.014840011 | 3 | 0.017943 | 2.5 | 1 | 152 | 10.171797 |
| A | 0.014840011 | 4 | 0.018614 | 2.5 | 1 | 190 | 12.776615 |
| A | 0.014840011 | 5 | 0.019468 | 2.5 | 1 | 228 | 15.381433 |
| A | 0.014840011 | 6 | 0.020461 | 2.5 | 2 | 266 | 17.97708 |
| A | 0.014840011 | 7 | 0.021564 | 2.5 | 5 | 304 | 20.574303 |
| A | 0.014840011 | 8 | 0.022816 | 2.5 | 5 | 342 | 23.178904 |
| A | 0.014840011 | 9 | 0.024114 | 2.5 | 5 | 380 | 25.838903 |
| A | 0.014840011 | 10 | 0.025962 | 2.5 | 5 | 418 | 28.38868 |
| A | 0.014840011 | 11 | 0.027848 | 2.5 | 6 | 456 | 31.04868 |
| A | 0.014840011 | 12 | 0.029162 | 2.5 | 7 | 494 | 33.70868 |
| A | 0.014840011 | 13 | 0.03214 | 2.5 | 8 | 532 | 36.36868 |
| A | 0.014840011 | 14 | 0.034762 | 2.5 | 12 | 570 | 39.02868 |
| A | 0.014840011 | 15 | 0.037948 | 2.5 | 13 | 608 | 41.68868 |
| A | 0.014840011 | 16 | 0.042829 | 2.5 | 15 | 646 | 44.34868 |
| A | 0.014840011 | 17 | 0.04862 | 2.5 | 15 | 684 | 47.00868 |
| A | 0.014840011 | 18 | 0.061574 | 2.5 | 15 | 722 | 49.66868 |
| A | 0.014840011 | 19 | 0.183596 | 2.5 | 17 | 758 | 52.18868 |

Alternatively, Table 1 may optionally include a last CVR threshold, which may be understood as a historical CVR threshold. In Table 1, the installation number of the N^{th} data set is a sum of the installment number of the previous N data sets, and the same principle for the accumulated click number and accumulated cost.

After the data as shown in Table 1 is generated, the CVR threshold may be obtained according to the steps described above. Explanation is made with reference to Table 2 for a clear description.

TABLE 2

| | | | | | Left | | |
|---|---|---|---|---|---|---|---|
| Name of APP | | | | Left cost | installations | | Left CPI |
| recommendation | Data set | | Last CVR | after data | after data | Desired | after data |
| information | No. | CVR | threshold | set removal | set removal | CPI | set removal |
| A | 0 | 0 | 0.01484 | 52.18868 | 17 | 2.5 | 3.069922 |
| A | 1 | 0.015695 | 0.01484 | 49.720501 | 17 | 2.5 | 2.924735 |
| A | 2 | 0.016383 | 0.01484 | 47.060501 | 17 | 2.5 | 2.768265 |
| A | 3 | 0.017186 | 0.01484 | 44.510783 | 17 | 2.5 | 2.618281 |
| A | 4 | 0.017943 | 0.01484 | 42.016883 | 16 | 2.5 | 2.626055 |
| A | 5 | 0.018614 | 0.01484 | 39.412065 | 16 | 2.5 | 2.463254 |
| A | 6 | 0.019468 | 0.01484 | 36.807247 | 16 | 2.5 | 2.300453 |
| A | 7 | 0.020461 | 0.01484 | 34.2116 | 15 | 2.5 | 2.280773 |
| A | 8 | 0.021564 | 0.01484 | 31.614377 | 12 | 2.5 | 2.634531 |
| A | 9 | 0.022816 | 0.01484 | 29.009776 | 12 | 2.5 | 2.417481 |
| A | 10 | 0.024114 | 0.01484 | 26.349777 | 12 | 2.5 | 2.195815 |
| A | 11 | 0.025962 | 0.01484 | 23.8 | 12 | 2.5 | 1.983333 |
| A | 12 | 0.027848 | 0.01484 | 21.14 | 11 | 2.5 | 1.921818 |
| A | 13 | 0.029162 | 0.01484 | 18.48 | 10 | 2.5 | 1.848 |
| A | 14 | 0.03214 | 0.01484 | 15.82 | 9 | 2.5 | 1.757778 |
| A | 15 | 0.034762 | 0.01484 | 13.16 | 5 | 2.5 | 2.632 |
| A | 16 | 0.037948 | 0.01484 | 10.5 | 4 | 2.5 | 2.625 |
| A | 17 | 0.042829 | 0.01484 | 7.84 | 2 | 2.5 | 3.92 |
| A | 18 | 0.04862 | 0.01484 | 5.18 | 2 | 2.5 | 2.59 |
| A | 19 | 0.061574 | 0.01484 | 2.52 | 2 | 2.5 | 1.26 |

It should be explained for the data in Table 2 that, No. 0 data set refers to a statistical result for left data sets after removing 0 data set, i.e. without removing any data set, No. 2 data set refers to a statistical result for left data sets after removing 2 data sets, and so on.

For example, it can be seen from Table 1, total_costs is 52.18868, and total_install is 17, therefore, in Table 2, left_costs after 1 data set is removed is 52.18868−2.468179=49.720501, and left_install (installation number) is 17−0=17, thus, CPI after 1 data set is removed=left_costs/left_install=2.924735, and the like for other data set removal.

After acquiring the data as shown in Table 2, it is possible to acquire the threshold by comparing the left . . . CPI with the desired CPI. For example, through comparing the data in last two columns in Table 2, it can be obtained that the threshold is 0.022816, i.e., corresponding to a CPI of 2.417481 which is acquired after removing 9 data sets and is closest to the desired CPI. It should be illustrated that, the CPI here is the installation parameter described above.

With the technical solution as described above, it is possible to generate an installation parameter closest to the desired installation parameter and thus take a CVR corresponding to installation parameter as the CVR threshold, in this way, it is possible to ensure the installation parameter generated when displaying the APP recommendation information is closest to the desired installation parameter. In addition, the desired installation parameter here may be provided by the manufacturer of the APP.

Furthermore, the historical statistical data described above may be acquired after being screened. For example, historical statistical data of the APP recommendation information with the installation number and the display number lower than a given value may be filtered out. Thus, it is easier to generate the CVR threshold with the screened historical statistical data.

Certainly, in this embodiment, the CVR threshold may be generated by taking a difference between a historical CVR threshold and a first specific value as the CVR threshold, if a difference between a cost of each installation of the APP paid by the manufacturer of the APP generated from the statistical set without removing any data set and the desired installation parameter is within the preset range.

Here, the historical CVR threshold may be a CVR last used. In this embodiment, the CVR threshold may be decreased simply through multiplying the historical CVR threshold by a reduction factor, so as to tentatively increase the times of the display of the APP recommendation information, and in such a case, an installation parameter of the APP recommendation information may also meet a requirement of the desired installation parameter, i.e., meet requirements of the APP manufacturer.

Certainly, in this embodiment, the CVR threshold may also be generated by taking a sum of the historical CVR threshold and a second specific value as the CVR threshold, if a difference between a cost of each installation of the APP paid by the manufacturer of the APP generated after a last data set removal from the statistical set and the desired installation parameter is not within the preset range.

As the desired installation parameter cannot be met even after the last data set removal, it is possible to acquire the CVR threshold by adding a specific value to the historical CVR threshold, for example by multiplying the last CVR threshold by an amplification factor, thus enlarging the last CVR threshold, such that it is facilitated to enable the installation parameter of the APP recommendation information to meet the requirement of the desired installation parameter, i.e., meet requirements of the APP manufacturer.

Certainly, in this embodiment, the CVR threshold may also be generated by taking an overall CVR of a Tth removed data set as the CVR threshold, if a difference between a cost of each installation of the APP paid by the manufacturer of the APP generated after a last data set removal from the statistical set and the desired installation parameter is not within the preset range, where T is a positive integer less than N.

In this way, it is possible to remove some data sets and take a corresponding CVR as the CVR threshold if the last CVR threshold is not present.

It should be illustrated that, steps of the method described above may be executed by a server, i.e., the server may achieve the method described above, but the CVR threshold may be received by the server from other equipment, that is, S301 may include: receiving the CVR threshold for the APP by the server from other equipment. Other equipment described herein may be understood to be any equipment which is connectable through data transmission with the above server. In such a case, the CVR threshold is generated by other equipment described above, i.e., the other equipment described above executes the step of generating the CVR threshold and sending the generated CVR threshold to the server to allow the server to execute S102 to S104.

Certainly, in some cases, the CVR threshold may be generated by the server itself, i.e., S101 may include the step of generating the CVR threshold, which is not limited herein.

In addition, it should be illustrated that, since it is only necessary to acquire or calculate one CVR threshold in this embodiment, both the calculation and storage are only related to the size of the APP recommendation information, such that consumptions for the calculation and storage are relatively small.

In this embodiment, by acquiring a CVR threshold for an APP, in which a difference between an installation parameter corresponding to the CVR threshold and a desired installation parameter is within a preset range, the installation parameter is related to an installation number and generated from historical statistical information in which a CVR is equal to or higher than the CVR threshold, and the historical statistical information is acquired from historical displays of the APP recommendation information of the APP; predicting a CVR for the APP recommendation information to be displayed; and determining whether the CVR predicted is lower than the CVR threshold, if yes, not displaying the APP recommendation information, if no, displaying the APP recommendation information, it is possible to display the APP recommendation information more intelligently based on the CVR thereof, as compared with the related art.

In the following, there are provided device embodiments, which are used to execute the method described in method embodiments, for brief illustration, only parts related to the device embodiments are described. For more specific technical details not shown in this section, the method embodiments of the present disclosure may be referred to.

Referring to FIG. 2, which is a schematic diagram of a device for displaying APP recommendation information according to an embodiment of the present disclosure, the device includes: an acquiring unit 21, a determining unit 22 and a displaying unit 23.

The acquiring unit 21 is configured to acquire a CVR threshold for an APP, in which a difference between an installation parameter corresponding to the CVR threshold and a desired installation parameter is within a preset range, the installation parameter is related to an installation number and generated from historical statistical information in which a CVR is equal to or higher than the CVR threshold, and the historical statistical information is acquired from historical displays of the APP recommendation information of the APP.

In this embodiment, the APP mentioned above may be any APP in the field of the internet technology, such as an instant messaging APP, a game APP, a reading APP, a video APP, and so on. Further, the APP recommendation information may be taken as installation information for a user terminal to install the APP, that is, the user terminal may acquire installation data of the APP from the APP recommendation information to install the APP. In addition, the APP recommendation information may also be understood as advertisements for generalizing the APP.

In this embodiment, CVR may be understood as an indication for evaluating the effect of the APP recommendation information or advertisements when the APP recommendation information is used as the advertisements.

In this embodiment, the historical statistical information may be statistical information that is acquired from historical displays of the APP recommendation information of the APP. For example, the historical statistical information may be an accumulated installation number of the APP, an accumulated cost of the APP paid by a manufacturer, an accumulated click number of the APP recommendation information or a CVR acquired at each display of the APP recommendation information, i.e., the historical statistical information may include at least one of an accumulated installation number, an accumulated cost of the APP paid by a manufacturer or a CVR acquired at each display of the APP recommendation information. In this way, the historical statistical information may include a final cost, a final installation number and a final click number as well as a cost, an installation number and a click number generated at each display of the APP recommendation information. Consequently, it is possible to calculate a parameter related to the installation number from the historical statistical information in which a CVR is equal to or higher than the CVR threshold. For example, if the CVR threshold is 0.02, and there is a CVR of 0.0198 in the historical statistical information, then it is possible to take a difference between the final cost and the cost corresponding to the CVR of 0.0198 as a left cost and a difference between the final installation number and the installation number corresponding to the CVR of 0.0198 as a left installation number, and thus it is possible to calculate the installation parameter according to the left cost and the left installation number.

Moreover, in this embodiment, the installation parameter corresponding to the CVR threshold may refer to information about a cost of each installation of the APP paid by the manufacturer of the APP, generated from the historical statistical information in which a CVR is equal to or higher than the CVR threshold. That is, the installation parameter may be the cost of each installation of the APP paid by the manufacturer of the APP, which may be defined as CPI. Thus, it is possible to control the cost of each installation of the APP paid by the manufacturer of the APP within a reasonable range, so as to improve the benefits of the manufacturer.

Furthermore, in this embodiment, the installation parameter may refer to a ratio of a display number of the APP recommendation information to the installation number of the APP, generated from the historical statistical information in which a CVR is equal to or higher than the CVR threshold. That is, the installation parameter may be the ratio of the display number of the APP recommendation information to the installation number of the APP. Thus, it is possible to control the display number of the APP recommendation information and the installation number of the APP within a reasonable range, so as to avoid a problem that displays of the APP recommendation information are excessive, but installation number of the APP is low.

The determining unit 22 is configured to predict a CVR for the APP recommendation information to be displayed and to determine whether the CVR predicted is lower than the CVR threshold.

The CVR predicted by the determining unit 22 for the APP recommendation information may be obtainable in a machine learning manner.

The displaying unit 23 is configured not to display the APP recommendation information if the determining unit 22 determines the CVR predicted is lower than the CVR threshold, or to display the APP recommendation information if the determining unit 22 determines the CVR predicted is not lower than the CVR threshold.

If the CVR predicted for the APP recommendation information to be displayed is lower than the CVR threshold, it is indicated that a difference between an installation parameter to be generated if the APP recommendation information is displayed and the desired installation parameter is not within the preset range, the displaying unit 23 will not display the APP recommendation information, thus the installation parameter of the APP may be controlled within a reasonable range. If the CVR predicted for the APP recommendation information to be displayed is greater than the CVR threshold, it is indicated that a difference between an installation parameter to be generated by displaying APP recommendation information and the desired installation parameter is within the preset range, thus the displaying unit 23 may display the APP recommendation information.

It should be illustrated that, in this embodiment, displaying the APP recommendation information may be understood as outputting the APP recommendation information in some specific interfaces or sending the APP recommendation information to the user terminal through a specific message.

With the units described above, it is possible to ensure the benefits of the manufacturer of the APP through not displaying useless APP recommendation information with a CVR less than the CVR threshold, without a bid adjustment of the APP recommendation information.

In this embodiment, when the installation parameter is the cost of each installation of the APP paid by the manufacturer of the APP, the CVR threshold may be generated by:

acquiring the desired installation parameter and historical statistical data generated from M displays of the APP recommendation information of the APP, where the historical statistical data includes information about CVR, installation number and cost, and M is an integer greater than 1;

taking the historical statistical data acquired as a statistical set, and dividing the historical statistical data in the statistical set into N data sets, in which each data set includes an overall CVR, and a difference between a CVR of each historical statistical data in the data set and the overall CVR is within a specific range, and N is a positive integer less than M;

removing from the statistical set a data set with a smallest overall CVR in the N data sets, and calculating a cost of each installation of the APP paid by the manufacturer of the APP from currently left statistical sets as a current installation parameter;

comparing the current installation parameter with the desired installation parameter, and taking the overall CVR of the currently removed data set as the CVR threshold if a difference between the current installation parameter and the desired installation parameter is within the preset range;

if the difference between the current installation parameter and the desired installation parameter is not within the preset range, removing from the currently left statistical sets a data set with a smallest overall CVR in the currently left statistical sets, and repeating the step of calculating a cost of each installation of the APP paid by the manufacturer of the APP from currently left statistical sets as a current installation parameter, until the CVR threshold is generated.

In this embodiment, each historical statistical data may correspond to one display of the APP recommendation information, the CVR included in the historical statistical data may be a CVR at the current display of the APP recommendation information, the installation number included in the historical statistical data may be an accumulated installation number at the current display of the APP recommendation information, and the cost information included in the historical statistical data may be an accumulated cost paid by the manufacturer of the APP at the current display of the APP recommendation information. Certainly, the historical statistical data may also include an accumulated click number at the current display of the APP recommendation information.

In addition, the number of the historical statistical data in each data set of the statistical set may be the same, or a CVR of each historical statistical data in each data set is equal to the overall CVR of the data set. For example, the historical statistical data may be ranked in an ascending order of the CVR and averagely divided into N data sets (or Bins) according to the display number. A serial number and a corresponding CVR value are recorded for each data set.

With the technical solution as described above, it is possible to generate an installation parameter closest to the desired installation parameter and thus take a CVR corresponding to installation parameter as the CVR threshold, in this way, it is possible to ensure the installation parameter generated when displaying the APP recommendation information is closest to the desired installation parameter. In addition, the desired installation parameter here may be provided by the manufacturer of the APP.

Furthermore, the historical statistical data described above may be acquired after being screened. For example, historical statistical data of the APP recommendation information with the installation number and the display number lower than a given value may be filtered out. Thus, it is easier to generate the CVR threshold with the screened historical statistical data.

Certainly, in this embodiment, the CVR threshold may be generated by taking a difference between a historical CVR threshold and a first specific value as the CVR threshold, if a difference between a cost of each installation of the APP paid by the manufacturer of the APP generated from the statistical set without removing any data set and the desired installation parameter is within the preset range.

Here, the historical CVR threshold may be a CVR last used. In this embodiment, the CVR threshold may be decreased simply through multiplying the historical CVR threshold by a reduction factor, so as to tentatively increase the times of the display of the APP recommendation information, and in such a case, an installation parameter of the APP recommendation information may also meet a requirement of the desired installation parameter, i.e., meet requirements of the APP manufacturer.

Certainly, in this embodiment, the CVR threshold may also be generated by taking a sum of the historical CVR threshold and a second specific value as the CVR threshold, if a difference between a cost of each installation of the APP paid by the manufacturer of the APP generated after a last data set removal from the statistical set and the desired installation parameter is not within the preset range.

As the requirement of the desired installation parameter cannot be met even after the last data set removal, it is possible to acquire the CVR threshold by adding a specific value to the historical CVR threshold, for example by multiplying the last CVR threshold by an amplification factor, thus enlarging the last CVR threshold, such that it is facilitated to enable the installation parameter of the APP recommendation information to meet the requirement of the desired installation parameter, i.e., meet requirements of the APP manufacturer.

Certainly, in this embodiment, the CVR threshold may also be generated by taking an overall CVR of a Tth removed data set as the CVR threshold, if a difference between a cost of each installation of the APP paid by the manufacturer of the APP generated after a last data set removal from the statistical set and the desired installation parameter is not within the preset range, where T is a positive integer less than N.

In this way, it is possible to remove some data sets and take a corresponding CVR as the CVR threshold if the last CVR threshold is not present.

It should be illustrated that, the device described above may be applied in a server, i.e., the server may include the device described above, but the CVR threshold may be received by the server from other equipment, that is, the acquiring unit 21 may be configured to receive the CVR threshold for the APP from other equipment. Other equipment described herein may be understood to be any equipment which is connectable through data transmission with the above server. In such a case, the CVR threshold is generated by the other equipment described above, i.e., the other equipment described above executes the step of generating the CVR threshold and sending the generated CVR threshold to the server.

Certainly, in some cases, the CVR threshold may be generated by the server itself, i.e., the acquiring unit 21 may execute an operation of generating the CVR threshold.

In addition, it should be illustrated that, since it is only necessary to acquire or calculate one CVR threshold in this embodiment, both the calculation and storage are only related to the size of the APP recommendation information, such that consumptions for the calculation and storage are relatively small.

In this embodiment, by acquiring a CVR threshold for an APP, in which a difference between an installation parameter corresponding to the CVR threshold and a desired installation parameter is within a preset range, the installation parameter is related to an installation number and generated from historical statistical information in which a CVR is equal to or higher than the CVR threshold, and the historical statistical information is acquired from historical displays of the APP recommendation information of the APP; predicting a CVR for the APP recommendation information to be displayed; and determining whether the CVR predicted is lower than the CVR threshold, if yes, not displaying the APP recommendation information, if no, displaying the APP recommendation information, it is possible to display the APP recommendation information more intelligently based on the CVR thereof, as compared with the related art.

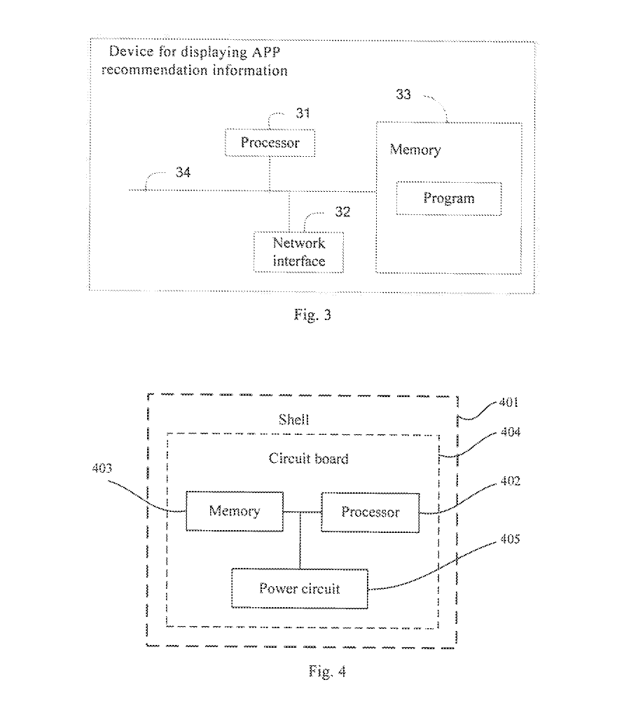

Referring to FIG. 3, which is a schematic diagram of a device for displaying APP recommendation information according to an embodiment of the present disclosure, the device includes: a processor 31, a network interface 32, a memory 33 and a communication bus 34. The communication bus 34 is configured to achieve a connection and communication among the processor 31. The network interface 32 and the memory 33. The processor is configured to execute a process stored in the memory 33 to achieve the method as follows:

acquiring a click value rate (CVR) threshold for an APP, in which a difference between an installation parameter corresponding to the CVR threshold and a desired installation parameter is within a preset range, the installation parameter is related to an installation number and generated from historical statistical information in which a CVR is equal to or higher than the CVR threshold, and the historical statistical information is acquired from historical displays of the APP recommendation information of the APP;

predicting a CVR for the APP recommendation information to be displayed; and

determining whether the CVR predicted is lower than the CVR threshold, if yes, not displaying the APP recommendation information, if no, displaying the APP recommendation information.

Alternatively, the historical statistical information may include at least one of an accumulated installation number, an accumulated cost of the APP paid by a manufacturer or a CVR acquired at each historical display of the APP recommendation information.

Alternatively, the installation parameter may refer to information about a cost of each installation of the APP paid by the manufacturer of the APP, generated from the historical statistical information in which a CVR is equal to or higher than the CVR threshold.

In this embodiment, the CVR threshold may be generated by:

acquiring the desired installation parameter and historical statistical data generated from M displays of the APP recommendation information of the APP, where the historical statistical data includes information about CVR, installation number and cost, and M is an integer greater than 1;

taking the historical statistical data acquired as a statistical set, and dividing the historical statistical data in the statistical set into N data sets, in which each data set includes an overall CVR, and a difference between a CVR of each historical statistical data in the data set and the overall CVR is within a specific range, and N is a positive integer less than M;

removing from the statistical set a data set with a smallest overall CVR in the N data sets, and calculating a cost of each installation of the APP paid by the manufacturer of the APP from currently left statistical sets as a current installation parameter;

comparing the current installation parameter with the desired installation parameter, and taking the overall CVR of the currently removed data set as the CVR threshold if a difference between the current installation parameter and the desired installation parameter is within the preset range;

if the difference between the current installation parameter and the desired installation parameter is not within the preset range, removing from the currently left statistical sets a data set with a smallest overall CVR in the currently left statistical sets, and repeating the step of calculating a cost of each installation of the APP paid by the manufacturer of the APP from currently left statistical sets as a current installation parameter, until the CVR threshold is generated.

In this embodiment, the CVR threshold may also be generated by:

taking a difference between a historical CVR threshold and a first specific value as the CVR threshold, if a difference between a cost of each installation of the APP paid by the manufacturer of the APP generated from the statistical set without removing any data set and the desired installation parameter is within the preset range; or

taking a sum of the historical CVR threshold and a second specific value as the CVR threshold, or taking an overall CVR of a Tth removed data set as the CVR threshold, if a difference between a cost of each installation of the APP paid by the manufacturer of the APP generated after a last data set removal from the statistical set and the desired installation parameter is not within the preset range, where T is a positive integer less than N.

Alternatively, the installation parameter may refer to a ratio of a display number of the APP recommendation information to the installation number of the APP, generated from the historical statistical information in which a CVR is equal to or higher than the CVR threshold.

In this embodiment, by acquiring a CVR threshold for an APP, in which a difference between an installation parameter corresponding to the CVR threshold and a desired installation parameter is within a preset range, the installation parameter is related to an installation number and generated from historical statistical information in which a CVR is equal to or higher than the CVR threshold, and the historical statistical information is acquired from historical displays of the APP recommendation information of the APP; predicting a CVR for the APP recommendation information to be displayed; and determining whether the CVR predicted is lower than the CVR threshold, if yes, not displaying the APP recommendation information, if no, displaying the APP recommendation information, it is possible to display the APP recommendation information more intelligently based on the CVR thereof, as compared with the related art.

In order to achieve the embodiments mentioned above, embodiments of the present disclosure further provide a device for displaying APP recommendation information. The device includes a shell 401, a processor 402, a memory 403, a circuit board 404 and a power circuit 405. The circuit board 404 is disposed in a space defined by the shell 401. The memory 403 is disposed on the circuit board 404 and configured to store an executable program code. The power circuit 405 is configured to supply power to each circuit or component of a device for displaying APP recommendation information. The processor 402 is disposed on the circuit board 404 and configured to run a program corresponding to the executable program code by reading the executable program code stored in the memory 403 to perform the following steps.

S101′. A CVR threshold is acquired for an APP, a difference between an installation parameter corresponding to the CVR threshold and a desired installation parameter is within a preset range, where the installation parameter is related to an installation number and generated from historical statistical information in which a CVR is equal to or higher than the CVR threshold, and the historical statistical information is acquired from historical displays of the APP recommendation information of the APP.

In this embodiment, the historical statistical information may be statistical information that is acquired from historical displays of the APP recommendation information of the APP. For example, the historical statistical information may be an accumulated installation number of the APP, an accumulated cost of the APP paid by a manufacturer, an accumulated click number of the APP recommendation information or a CVR acquired at each display of the APP recommendation information, i.e., the historical statistical information may include at least one of an accumulated installation number, an accumulated cost of the APP paid by a manufacturer or a CVR acquired at each display of the APP recommendation information. In this way, the historical statistical information may include a final cost, a final installation number and a final click number as well as a cost, an installation number and a click number generated at each display of the APP recommendation information. Consequently, it is possible to calculate a parameter related to the installation number from the historical statistical information in which a CVR is equal to or higher than the CVR threshold. For example, if the CVR threshold is 0.02, and there is a CVR of 0.0198 in the historical statistical information, then it is possible to take a difference between the final cost and the cost corresponding to the CVR of 0.0198 as a left cost and a difference between the final installation number and the installation number corresponding to the CVR of 0.0198 as a left installation number, and thus it is possible to calculate the installation parameter according to the left cost and the left installation number. In addition, the historical statistical information may be acquired within a specific time period.

Moreover, in this embodiment, the installation parameter corresponding to the CVR threshold may refer to information about a cost of each installation of the APP paid by the manufacturer of the APP, generated from the historical statistical information in which a CVR is equal to or higher than the CVR threshold. That is, the installation parameter may be a cost of each installation of the APP paid by the manufacturer of the APP, which may be defined as CPI. Thus, it is possible to control the cost of each installation of the APP paid by the manufacturer of the APP within a reasonable range, so as to improve the benefits of the manufacturer.

Furthermore, in this embodiment, the installation parameter may refer to a ratio of a display number of the APP recommendation information to the installation number of the APP, generated from the historical statistical information in which a CVR is equal to or higher than the CVR threshold. That is, the installation parameter may be the ratio of the display number of the APP recommendation information to the installation number of the APP. Thus, it is possible to control the display number of the APP recommendation information and the installation number of the APP within a reasonable range, so as to avoid a problem that displays of the APP recommendation information are excessive, but installation number of the APP is low.

S102′. A CVR is predicted for the APP recommendation information to be displayed, and it is determined whether the CVR predicted is lower than the CVR threshold, if yes, S103′ is executed, if no, S104′ is executed.

S103′. The APP recommendation information will not be displayed.

If the CVR predicted for the APP recommendation information to be displayed is lower than the CVR threshold, it is indicated that a difference between an installation parameter to be generated if the APP recommendation information is displayed and the desired installation parameter is not within the preset range, the APP recommendation information will not be displayed, thus the installation parameter of the APP is controlled within a reasonable range.

S104′. The APP recommendation information is displayed.

If the CVR predicted for the APP recommendation information to be displayed is greater than the CVR threshold, it is indicated that a difference between an installation parameter to be generated by displaying the APP recommendation information and the desired installation parameter is within the preset range, thus the APP recommendation information may be displayed.

In this embodiment, when the installation parameter is the cost of each installation of the APP paid by the manufacturer of the APP, the CVR threshold may be generated by:

acquiring the desired installation parameter and historical statistical data generated from M displays of the APP recommendation information of the APP, where the historical statistical data includes information about CVR, installation number and cost, and M is an integer greater than 1;

taking the historical statistical data acquired as a statistical set, and dividing the historical statistical data in the statistical set into N data sets, in which each data set includes an overall CVR, and a difference between a CVR of each historical statistical data in the data set and the overall CVR is within a specific range, and N is a positive integer less than M;

removing from the statistical set a data set with a smallest overall CVR in the N data sets, and calculating a cost of each installation of the APP paid by the manufacturer of the APP from currently left statistical sets as a current installation parameter;

comparing the current installation parameter with the desired installation parameter, and taking the overall CVR of the currently removed data set as the CVR threshold if a difference between the current installation parameter and the desired installation parameter is within the preset range;

if the difference between the current installation parameter and the desired installation parameter is not within the preset range, removing from the currently left statistical sets a data set with a smallest overall CVR in the currently left statistical sets, and repeating the step of calculating a cost of each installation of the APP paid by the manufacturer of the APP from currently left statistical sets as a current installation parameter, until the CVR threshold is generated.

Certainly, in this embodiment, the CVR threshold may also be generated by taking a difference between a historical CVR threshold and a first specific value as the CVR threshold, if a difference between a cost of each installation of the APP paid by the manufacturer of the APP generated from the statistical set without removing any data set and the desired installation parameter is within the preset range.

Certainly, in this embodiment, the CVR threshold may also be generated by taking a sum of the historical CVR threshold and a second specific value as the CVR threshold, if a difference between a cost of each installation of the APP paid by the manufacturer of the APP generated after a last data set removal from the statistical set and the desired installation parameter is not within the preset range.

Certainly, in this embodiment, the CVR threshold may also be generated by taking an overall CVR of a Tth removed data set as the CVR threshold, if a difference between a cost of each installation of the APP paid by the manufacturer of the APP generated after a last data set removal from the statistical set and the desired installation parameter is not within the preset range, where T is a positive integer less than N.

It should be appreciated that, implementation details in the above steps can be referred to the corresponding method embodiments described above, and will not be elaborated herein.

In order to achieve embodiments as described above, embodiments of the present disclosure provide a computer program, which when running on a processor, performs a method for displaying APP recommendation information according to embodiments of the present disclosure. The method for displaying APP recommendation information includes:

acquiring a click value rate (CVR) threshold for an APP, in which a difference between an installation parameter corresponding to the CVR threshold and a desired installation parameter is within a preset range, the installation parameter is related to an installation number and generated from historical statistical information in which a CVR is equal to or higher than the CVR threshold, and the historical statistical information is acquired from historical displays of the APP recommendation information of the APP;

predicting a CVR for the APP recommendation information to be displayed; and

determining whether the CVR predicted is lower than the CVR threshold, if yes, not displaying the APP recommendation information, if no, displaying the APP recommendation information.

It should be appreciated that, implementation details in the above steps can be referred to the corresponding method embodiments described above, and will not be elaborated herein.

In order to achieve embodiments as described above, embodiments of the present disclosure provide a computer-readable storage medium, having stored therein one or more modules that, when executed by a terminal, causes the terminal to perform a method for displaying APP recommendation information according to embodiments of the present disclosure. The method for displaying APP recommendation information includes:

acquiring a click value rate (CVR) threshold for an APP, in which a difference between an installation parameter corresponding to the CVR threshold and a desired installation parameter is within a preset range, the installation parameter is related to an installation number and generated from historical statistical information in which a CVR is equal to or higher than the CVR threshold, and the historical statistical information is acquired from historical displays of the APP recommendation information of the APP;

predicting a CVR for the APP recommendation information to be displayed; and

determining whether the CVR predicted is lower than the CVR threshold, if yes, not displaying the APP recommendation information, if no, displaying the APP recommendation information.

It should be appreciated that, implementation details in the above steps can be referred to the corresponding method embodiments described above, and will not be elaborated herein.

Any process or method described in a flow chart or described herein in other ways may be understood to include one or more modules, segments or portions of codes of executable instructions for achieving specific logical functions or steps in the process, and the scope of a preferred embodiment of the present disclosure includes other implementations, which may not follow a shown or discussed order according to the related functions in a substantially simultaneous manner or in a reverse order, to perform the function, which should be understood by those skilled in the art.

The logic and/or step described in other manners herein or shown in the flow chart, for example, a particular sequence table of executable instructions for realizing the logical function, may be specifically achieved in any computer readable medium to be used by the instruction execution system, device or equipment (such as the system based on computers, the system comprising processors or other systems capable of obtaining the instruction from the instruction execution system, device and equipment and executing the instruction), or to be used in combination with the instruction execution system, device and equipment. As to the specification, “the computer readable medium” may be any device adaptive for including, storing, communicating, propagating or transferring programs to be used by or in combination with the instruction execution system, device or equipment. More specific examples of the computer readable medium comprise but are not limited to: an electronic connection (an electronic device) with one or more wires, a portable computer enclosure (a magnetic device), a random access memory (RAM), a read only memory (ROM), an erasable programmable read-only memory (EPROM or a flash memory), an optical fiber device and a portable compact disk read-only memory (CDROM). In addition, the computer readable medium may even be a paper or other appropriate medium capable of printing programs thereon, this is because, for example, the paper or other appropriate medium may be optically scanned and then edited, decrypted or processed with other appropriate methods when necessary to obtain the programs in an electric manner, and then the programs may be stored in the computer memories.

It should be understood that each part of the present disclosure may be realized by the hardware, software, firmware or their combination. In the above embodiments, a plurality of steps or methods may be realized by the software or firmware stored in the memory and executed by the appropriate instruction execution system. For example, if it is realized by the hardware, likewise in another embodiment, the steps or methods may be realized by one or a combination of the following techniques known in the art: a discrete logic circuit having a logic gate circuit for realizing a logic function of a data signal, an application-specific integrated circuit having an appropriate combination logic gate circuit, a programmable gate array (PGA), a field programmable gate array (FPGA), etc.

It can be understood that all or part of the steps in the method of the above embodiments can be implemented by instructing related hardware via programs, the program may be stored in a computer readable storage medium, and the program includes one step or combinations of the steps of the method when the program is executed.

In addition, each functional unit in the present disclosure may be integrated in one progressing module, or each functional unit exists as an independent unit, or two or more functional units may be integrated in one module. The integrated module can be embodied in hardware, or software. If the integrated module is embodied in software and sold or used as an independent product, it can be stored in the computer readable storage medium.

The storage medium mentioned above may be read-only memories, magnetic disks, CD, etc. Although explanatory embodiments have been shown and described hereinbefore, it would be appreciated by those skilled in the art that the above embodiments are explanatory and illustrative, cannot be construed to limit the present disclosure, and changes, alternatives, and modifications can be made in the embodiments without departing from spirit, principles and scope of the present disclosure.

Reference throughout this specification to “an embodiment,” “some embodiments,” “one embodiment”, “another example,” “an example,” “a specific example,” or “some examples,” means that a particular feature, structure, material, or characteristic described in connection with the embodiment or example is included in at least one embodiment or example of the present disclosure. Thus, the appearances of the phrases such as “in some embodiments,” “in one embodiment”, “in an embodiment”, “in another example,” “in an example,” “in a specific example,” or “in some examples,” in various places throughout this specification are not necessarily referring to the same embodiment or example of the present disclosure. Furthermore, the particular features, structures, materials, or characteristics may be combined in any suitable manner in one or more embodiments or examples. Moreover, it will be apparent to those skilled in the art that various embodiments or examples, as well as features of different embodiments or examples described throughout this specification, may be combined and combined without contradictory.

What is claimed is:

1. A method for displaying APP recommendation information, comprising:
acquiring a CVR threshold for an APP, wherein a difference between an installation parameter corresponding to the CVR threshold and a desired installation parameter is within a preset range, the installation parameter is related to an installation number and generated from historical statistical information in which a CVR is equal to or higher than the CVR threshold, and the historical statistical information is acquired from historical displays of the APP recommendation information of the APP;
predicting a CVR for the APP recommendation information to be displayed; and
determining whether the CVR predicted is lower than the CVR threshold, if yes, not displaying the APP recommendation information, if no, displaying the APP recommendation information.

2. The method according to claim 1, wherein the historical statistical information comprises: at least one of an accumulated installation number, an accumulated cost of the APP paid by a manufacturer or a CVR acquired at each historical display of the APP recommendation information.

3. The method according to claim 1, wherein the installation parameter comprises information about a cost of each installation of the APP paid by the manufacturer of the APP, generated from the historical statistical information in which a CVR is equal to or higher than the CVR threshold.

4. The method according to claim 1, wherein the installation parameter comprises a ratio of a display number of the APP recommendation information to the installation number of the APP, generated from the historical statistical information in which a CVR is equal to or higher than the CVR threshold.

5. The method according to claim 1, wherein the CVR threshold is generated by:
acquiring the desired installation parameter and historical statistical data generated from M displays of the APP recommendation information of the APP, where the historical statistical data comprises information about CVR, installation number and cost, and M is an integer greater than 1;
taking the historical statistical data acquired as a statistical set, and dividing the historical statistical data in the statistical set into N data sets, wherein each data set comprises an overall CVR, and a difference between a CVR of each historical statistical data in the data set and the overall CVR is within a specific range, and wherein N is a positive integer less than M;
removing from the statistical set a data set with a smallest overall CVR in the N data sets, and calculating a cost of each installation of the APP paid by the manufacturer of the APP from currently left statistical sets as a current installation parameter;
comparing the current installation parameter with the desired installation parameter, and taking the overall CVR of the currently removed data set as the CVR threshold if a difference between the current installation parameter and the desired installation parameter is within the preset range;
if the difference between the current installation parameter and the desired installation parameter is not within the preset range, removing from the currently left statistical sets a data set with a smallest overall CVR in the currently left statistical sets, and repeating the step of calculating a cost of each installation of the APP paid by the manufacturer of the APP from currently left statistical sets as a current installation parameter, until the CVR threshold is generated.

6. The method according to claim 5, wherein the CVR threshold is further generated by:
taking a difference between a historical CVR threshold and a first specific value as the CVR threshold, if a difference between a cost of each installation of the APP paid by the manufacturer of the APP generated from the statistical set without removing any data set, and the desired installation parameter is within the preset range; or
taking a sum of the historical CVR threshold and a second specific value as the CVR threshold, or taking an overall CVR of a Tth removed data set as the CVR threshold, if a difference between a cost of each installation of the APP paid by the manufacturer of the APP generated after a last data set removal from the statistical set, and the desired installation parameter is not within the preset range, where T is a positive integer less than N.

7. A device for displaying APP recommendation information, comprising:
a shell;
a circuit board, disposed in a space defined by the shell;
a memory, disposed on the circuit board and configured to store an executable program code;
a power circuit, configured to supply power to each circuit or component of an electronic device; and
a processor, disposed on the circuit board and configured to run a program corresponding to the executable program code by reading the executable program code stored in the memory to perform:
acquiring a CVR threshold for an APP, wherein a difference between an installation parameter corresponding to the CVR threshold and a desired installation parameter is within a preset range, the installation parameter is related to an installation number and generated from historical statistical information in which a CVR is equal to or higher than the CVR threshold, and the historical statistical information is acquired from historical displays of the APP recommendation information of the APP;
predicting a CVR for the APP recommendation information to be displayed; and
determining whether the CVR predicted is lower than the CVR threshold, if yes, not displaying the APP recommendation information, if no, displaying the APP recommendation information.

8. A computer-readable storage medium, having stored therein one or more modules that, when executed by a terminal, causes the terminal to perform a method for displaying APP recommendation information, the method comprising:
acquiring a CVR threshold for an APP, wherein a difference between an installation parameter corresponding to the CVR threshold and a desired installation parameter is within a preset range, the installation parameter is related to an installation number and generated from historical statistical information in which a CVR is equal to or higher than the CVR threshold, and the historical statistical information is acquired from historical displays of the APP recommendation information of the APP;
predicting a CVR for the APP recommendation information to be displayed; and
determining whether the CVR predicted is lower than the CVR threshold, if yes, not displaying the APP recommendation information, if no, displaying the APP recommendation information.

9. The method according to claim 2, wherein the CVR threshold is generated by:
acquiring the desired installation parameter and historical statistical data generated from M displays of the APP recommendation information of the APP, where the historical statistical data comprises information about CVR, installation number and cost, and M is an integer greater than 1;
taking the historical statistical data acquired as a statistical set, and dividing the historical statistical data in the statistical set into N data sets, wherein each data set comprises an overall CVR, and a difference between a CVR of each historical statistical data in the data set and the overall CVR is within a specific range, and wherein N is a positive integer less than M;
removing from the statistical set a data set with a smallest overall CVR in the N data sets, and calculating a cost of each installation of the APP paid by the manufacturer of the APP from currently left statistical sets as a current installation parameter;
comparing the current installation parameter with the desired installation parameter, and taking the overall CVR of the currently removed data set as the CVR threshold if a difference between the current installation parameter and the desired installation parameter is within the preset range;
if the difference between the current installation parameter and the desired installation parameter is not within the preset range, removing from the currently left statistical sets a data set with a smallest overall CVR in the currently left statistical sets, and repeating the step of calculating a cost of each installation of the APP paid by the manufacturer of the APP from currently left statistical sets as a current installation parameter, until the CVR threshold is generated.

10. The method according to claim 3, wherein the CVR threshold is generated by:
acquiring the desired installation parameter and historical statistical data generated from M displays of the APP recommendation information of the APP, where the historical statistical data comprises information about CVR, installation number and cost, and M is an integer greater than 1;
taking the historical statistical data acquired as a statistical set, and dividing the historical statistical data in the statistical set into N data sets, wherein each data set comprises an overall CVR, and a difference between a CVR of each historical statistical data in the data set and the overall CVR is within a specific range, and wherein N is a positive integer less than M;
removing from the statistical set a data set with a smallest overall CVR in the N data sets, and calculating a cost of each installation of the APP paid by the manufacturer of the APP from currently left statistical sets as a current installation parameter;
comparing the current installation parameter with the desired installation parameter, and taking the overall CVR of the currently removed data set as the CVR threshold if a difference between the current installation parameter and the desired installation parameter is within the preset range;
if the difference between the current installation parameter and the desired installation parameter is not within the preset range, removing from the currently left statistical sets a data set with a smallest overall CVR in the currently left statistical sets, and repeating the step of calculating a cost of each installation of the APP paid by the manufacturer of the APP from currently left statistical sets as a current installation parameter, until the CVR threshold is generated.

11. The method according to claim 4, wherein the CVR threshold is generated by:
acquiring the desired installation parameter and historical statistical data generated from M displays of the APP recommendation information of the APP, where the historical statistical data comprises information about CVR, installation number and cost, and M is an integer greater than 1;
taking the historical statistical data acquired as a statistical set, and dividing the historical statistical data in the statistical set into N data sets, wherein each data set comprises an overall CVR, and a difference between a CVR of each historical statistical data in the data set and the overall CVR is within a specific range, and wherein N is a positive integer less than M;
removing from the statistical set a data set with a smallest overall CVR in the N data sets, and calculating a cost of each installation of the APP paid by the manufacturer of the APP from currently left statistical sets as a current installation parameter;
comparing the current installation parameter with the desired installation parameter, and taking the overall CVR of the currently removed data set as the CVR threshold if a difference between the current installation parameter and the desired installation parameter is within the preset range;
if the difference between the current installation parameter and the desired installation parameter is not within the preset range, removing from the currently left statistical sets a data set with a smallest overall CVR in the currently left statistical sets, and repeating the step of calculating a cost of each installation of the APP paid by the manufacturer of the APP from currently left statistical sets as a current installation parameter, until the CVR threshold is generated.

12. The method according to claim 9, wherein the CVR threshold is further generated by:
taking a difference between a historical CVR threshold and a first specific value as the CVR threshold, if a difference between a cost of each installation of the APP paid by the manufacturer of the APP generated from the statistical set without removing any data set, and the desired installation parameter is within the preset range; or
taking a sum of the historical CVR threshold and a second specific value as the CVR threshold, or taking an overall CVR of a Tth removed data set as the CVR threshold, if a difference between a cost of each installation of the APP paid by the manufacturer of the APP generated after a last data set removal from the statistical set, and the desired installation parameter is not within the preset range, where T is a positive integer less than N.

13. The method according to claim 10, wherein the CVR threshold is further generated by:
taking a difference between a historical CVR threshold and a first specific value as the CVR threshold, if a difference between a cost of each installation of the APP paid by the manufacturer of the APP generated from the statistical set without removing any data set, and the desired installation parameter is within the preset range; or
taking a sum of the historical CVR threshold and a second specific value as the CVR threshold, or taking an overall CVR of a Tth removed data set as the CVR threshold, if a difference between a cost of each installation of the APP paid by the manufacturer of the APP generated after a last data set removal from the statistical set, and the desired installation parameter is not within the preset range, where T is a positive integer less than N.

14. The method according to claim 11, wherein the CVR threshold is further generated by:
taking a difference between a historical CVR threshold and a first specific value as the CVR threshold, if a difference between a cost of each installation of the APP paid by the manufacturer of the APP generated from the statistical set without removing any data set, and the desired installation parameter is within the preset range; or
taking a sum of the historical CVR threshold and a second specific value as the CVR threshold, or taking an overall CVR of a Tth removed data set as the CVR threshold, if a difference between a cost of each installation of the APP paid by the manufacturer of the APP generated after a last data set removal from the statistical set, and the desired installation parameter is not within the preset range, where T is a positive integer less than N.

15. The device according to claim 7, wherein the historical statistical information comprises: at least one of an accumulated installation number, an accumulated cost of the APP paid by a manufacturer or a CVR acquired at each historical display of the APP recommendation information.

16. The device according to claim 7, wherein the installation parameter comprises information about a cost of each installation of the APP paid by the manufacturer of the APP, generated from the historical statistical information in which a CVR is equal to or higher than the CVR threshold.

17. The device according to claim 7, wherein the installation parameter comprises a ratio of a display number of the APP recommendation information to the installation number of the APP, generated from the historical statistical information in which a CVR is equal to or higher than the CVR threshold.

18. The device according to claim 7, wherein the CVR threshold is generated by:
acquiring the desired installation parameter and historical statistical data generated from M displays of the APP recommendation information of the APP, where the historical statistical data comprises information about CVR, installation number and cost, and M is an integer greater than 1;
taking the historical statistical data acquired as a statistical set, and dividing the historical statistical data in the statistical set into N data sets, wherein each data set comprises an overall CVR, and a difference between a CVR of each historical statistical data in the data set and the overall CVR is within a specific range, and wherein N is a positive integer less than M;
removing from the statistical set a data set with a smallest overall CVR in the N data sets, and calculating a cost of each installation of the APP paid by the manufacturer of the APP from currently left statistical sets as a current installation parameter;
comparing the current installation parameter with the desired installation parameter, and taking the overall CVR of the currently removed data set as the CVR threshold if a difference between the current installation parameter and the desired installation parameter is within the preset range;
if the difference between the current installation parameter and the desired installation parameter is not within the preset range, removing from the currently left statistical sets a data set with a smallest overall CVR in the currently left statistical sets, and repeating the step of calculating a cost of each installation of the APP paid by the manufacturer of the APP from currently left statistical sets as a current installation parameter, until the CVR threshold is generated.

19. The device according to claim 18, wherein the CVR threshold is further generated by:
taking a difference between a historical CVR threshold and a first specific value as the CVR threshold, if a difference between a cost of each installation of the APP paid by the manufacturer of the APP generated from the statistical set without removing any data set, and the desired installation parameter is within the preset range; or
taking a sum of the historical CVR threshold and a second specific value as the CVR threshold, or taking an overall CVR of a Tth removed data set as the CVR threshold, if a difference between a cost of each installation of the APP paid by the manufacturer of the APP generated after a last data set removal from the statistical set, and the desired installation parameter is not within the preset range, where T is a positive integer less than N.
